(19) United States
(12) Patent Application Publication
(10) Pub. No.: US 2006/0214028 A1
(43) Pub. Date: Sep. 28, 2006

(54) Dispensing device for atomized reactive material, system and method of use thereof

(76) Inventor: Anthony J. Hynes, Burnt Hills, NY (US)

Correspondence Address: Schmeiser, Olsen & Watts LLP;Suite 201, 3 Lear Jet Lane, Latham, NY, 12110, US

(21) Appl. No.: 11/089,617

(22) Filed: Mar. 25, 2005

(51) Int. Cl. F23D 11/16

(52) U.S. Cl. 239/419.5; 239/569; 239/68; 239/407; 239/428.5

(57) ABSTRACT

The invention relates generally to a atomized, reactive material dispensing device, system and method of using the same. Disclosed is a dispensing device which includes a metering control that regulates the flow of the anaerobic, reactive fluid; and an atomizing. Also disclosed is a method for dispensing an atomized, anaerobic, reactive fluid which includes providing a device for dispensing the atomized, anaerobic reactive fluid; providing a reservoir for anaerobic, reactive fluid; and dispensing onto a workpiece the atomized, anaerobic, reactive fluid. Also disclosed is a dispensing system which includes a reservoir for anaerobic, reactive fluid; a dispensing device for dispensing the atomized, anaerobic, reactive fluid; and a multi-degree of freedom robotic apparatus operationally coupled to the dispensing device.

### BACKGROUND OF THE INVENTION

1. Field of the Invention

The present invention relates to a device, a method, and a system for dispensing atomized, anaerobic, reactive fluids, and in particular, cyanoacrylate fluids.

2. Related Art

In the field of material dispensing, efforts toward devices and systems able to effectively dispense anaerobic, reactive materials are continuously being made, especially, materials in an atomized form. However, the material composition of the devices are not such that the anaerobic, reactive fluid such as cyanoacrylate fluid, flowing therethrough would not cure or set therein. Accordingly, such devices often require disassembly after each use for cleaning and/or maintenance.

Further, the costs of maintenance and cleaning of the devices and the systems is highly regarded. With most material dispensing devices and systems, significant man-hours and manufacturing downtime, which translate into costs, must be expended to clean the devices and the systems between dispensing cycles, uses, workshifts, or material changes. Another need exists to provide an atomized, anaerobic system for highly reactive fluids.

Thus, there is a need for a device, system and method which overcomes the aforementioned, and other, deficiencies in the art of dispensing atomized, anaerobic, reactive fluid materials.

### SUMMARY OF THE INVENTION

In a first general aspect, in accordance with the present invention, providing a device for dispensing anaerobic, reactive fluids comprising: a metering control, wherein the metering control regulates a flow of an anaerobic, reactive fluid to an atomizer assembly; and an atomizer assembly, made of the anaerobic, reactive fluid resistant material, wherein the atomizer assembly atomizes the anaerobic, reactive fluid affording an atomized anaerobic, reactive fluid, and further wherein the atomizer assembly includes a nozzle, made of an anaerobic, reactive fluid resistant material, wherein the nozzle dispenses onto a workpiece the atomized anaerobic, reactive fluid.

In a second general aspect, in accordance with the present invention, providing a method for dispensing an anaerobic, reactive fluid comprising: providing a dispensing device for dispensing an anaerobic, reactive fluid, wherein the anaerobic, reactive fluid is dispensed in an atomized form; providing a reservoir for containing anaerobic, reactive fluid, wherein the reservoir is in fluid communication with the dispensing device; and dispensing onto a workpiece the atomized, anaerobic, reactive fluid.

In a third general aspect, in accordance with the present invention, providing a dispensing system comprising: a reservoir for containing an anaerobic, reactive fluid; a dispensing device having an internal surface for dispensing atomized, anaerobic, reactive fluid in fluid communication with the reservoir; a multi-degree of freedom robotic apparatus operationally coupled to the dispensing device; and a drive system, for supplying motive power to move the robotic apparatus in multi-degrees of freedom, the drive system operationally coupled to the robotic apparatus.

### BRIEF DESCRIPTION OF THE DRAWINGS

Some of the embodiments of this invention will be described in detail, with reference to the following figures, wherein like designations denote like members wherein:

FIG. 1 depicts a top perspective view of a dispensing device in accordance with the present invention;

FIG. 2 depicts a front view of the dispensing device in accordance with the present invention;

FIG. 3 depicts a side view of the dispensing device in accordance with the present invention;

FIG. 4 depicts a top view of the dispensing device in accordance with the present invention;

FIG. 5 depicts a Cartesian coordinate system used in describing the motion of a method and a system for dispensing material in accordance with the present invention;

FIG. 6 depicts a top view fo a dispensing system in accordance with the present invention;

FIG. 7 depicts a side view of the dispensing system in accordance with the present invention;

FIG. 8 depicts a front view of the dispensing system in accordance with the present invention; and

FIG. 9 depicts a block diagram of a robotic apparatus controller of the dispensing system in accordance with the present invention.

### DETAILED DESCRIPTION OF PREFERRED EMBODIMENTS

Although certain preferred embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of an embodiment. The features and advantages of the present invention are illustrated in detail in the accompanying drawings, wherein like reference numerals refer to like elements throughout the drawings.

The present invention offers a device for dispensing atomized, anaerobic, reactive fluids, especially cyanoacrylate. Although for purposes of illustration only, an embodiment that can be used for dispensing inter alia atomized, anaerobic, reactive fluids is disclosed herein. The apparatus and method can be readily used for dispensing other materials where dispensing of atomized fluids is required.

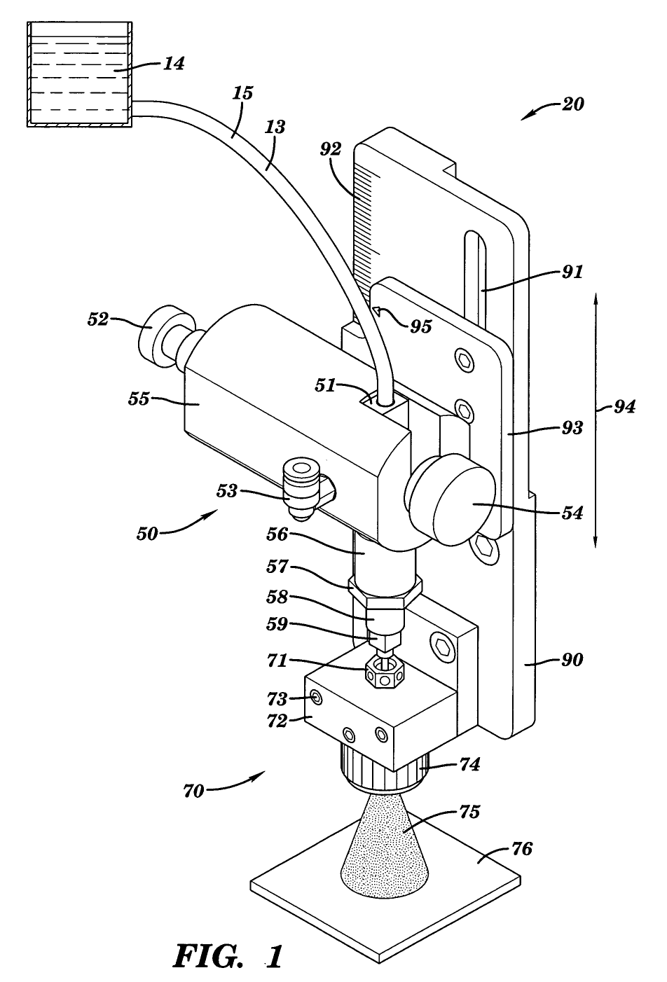

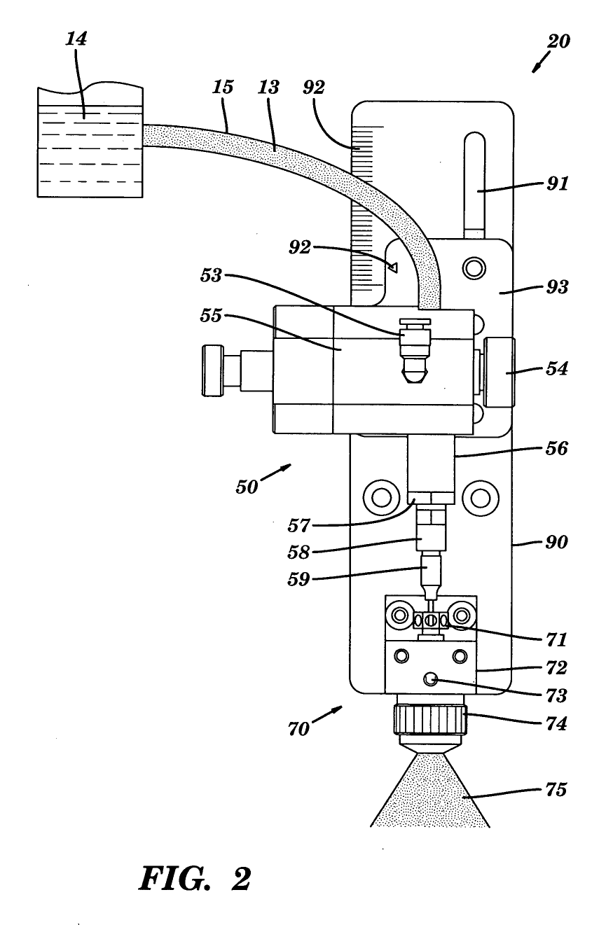

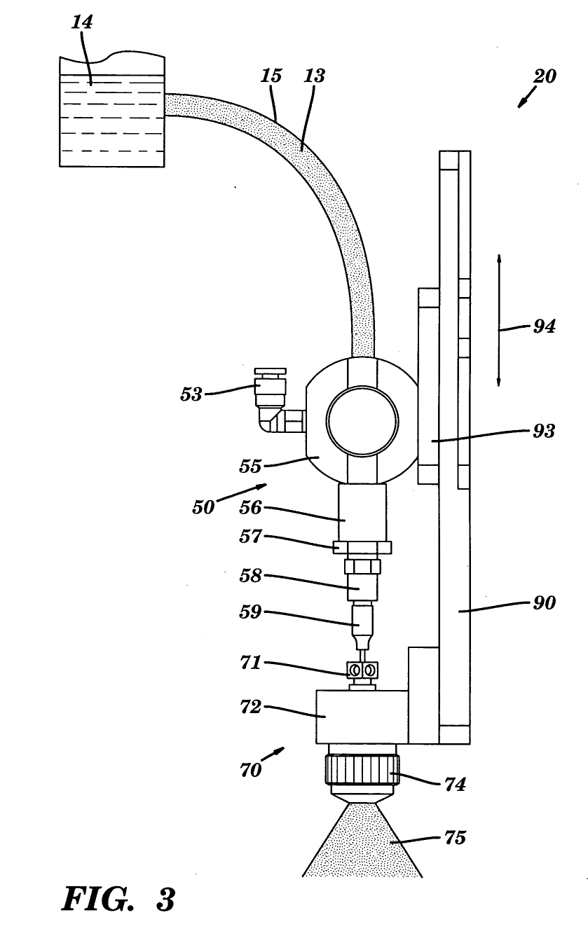

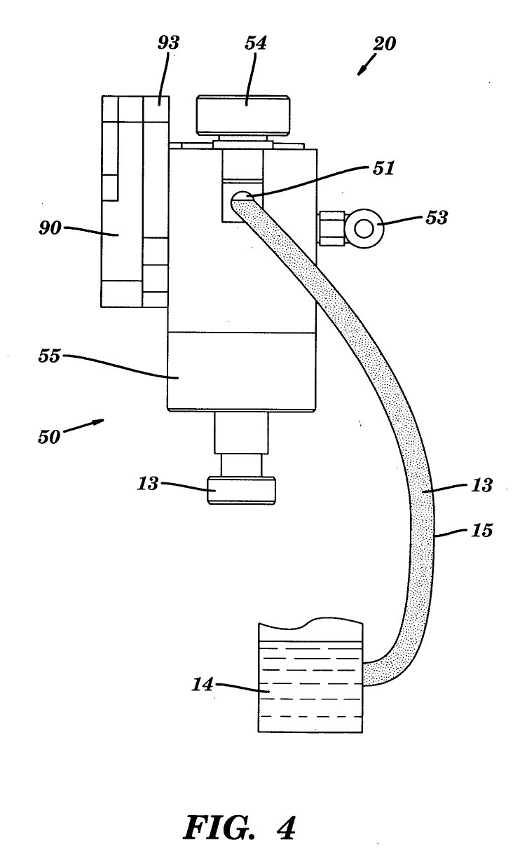

Referring to FIGS. 1, 2, 3, and 4 which depict various views of a dispensing device 20 for dispensing anaerobic, reactive fluids, in accordance with the present invention. An embodiment of the present invention is the dispensing device 20 comprising a metering control 50, an atomizing assembly 70, and a base plate 90. An anaerobic, reactive fluid dispensing conduit 15 is operationally coupled to an inlet port 51 of the metering control 50. The fluid dispensing conduit 15 interconnects a fluid supply, or reservoir 14, of anaerobic, reactive fluid 13, shown schematically, to the metering control 50 allowing the fluid 13 to flow from the reservoir 14 to the metering control 50. The metering control 50 comprises: a stroke adjust 52, an internal anul 53, a fluid dispensing conduit screw 54, and a metering control housing 55. The stroke adjust 52 controls the volume of fluid 13 that flows through the dispensing conduit 15 to the metering control 50 via the inlet port 51.

The metering control 50 further comprises: a threaded fitting 56, a double-ended male adapter 57, a Luer® lock 58, and a needle 59. The threaded fitting 56 is operationally coupled to the metering housing 55 at a first end and has a threaded female joint at a second, distal end. The female joint of the fitting 56 is able to accommodate a first end of the male adapter leaving the a second, distal end of the adapter 57 for attachment to the Luer® lock 58. The needle 59 is attached to the bottom of the Luer® lock 58 with a tip of the needle 59 extending into an inlet chamber 71 of an atomizing assembly 70.

Using the threaded fitting 56, the male or female adapter 57, the Luer® lock 58, and the needle 59 as previously described, to allow for the anaerobic, reactive fluid 13 to travel from the inlet port 51 out the needle 59 is not meant to limit the scope of the components that may be used in an embodiment of the present invention. Other components, inter alia fittings, such as Snap-tite, Swagelock®, integral or non-integral, and the like may be used individually and combinations thereof in accordance with the device of the present invention.

The atomizing assembly 70 comprises: the inlet chamber 71, an atomizer 72, air inlets 73, and a nozzle 74. The inlet chamber 71 is an opening for the anaerobic, reactive fluid 13 to enter the atomizer 72. The atomizer 72 atomizes the anaerobic, reactive fluid 13 affording an atomized anaerobic, reactive fluid 75 in a state comprising of atomized droplets. The term atomize means reducing material, such as a solid, liquid or combinations thereof, to fine particles, droplets, a spray, and the like. The air inlets 73 deliver compressed air to the atomizer 72 to carry the atomized fluid 75 to the nozzle 74. The nozzle 74 delivers the atomized fluid 75 to a workpiece 76, such as a substrate, for application purposes.

The metering control valve 50 and the atomizing assembly 70 are attached to the base plate 90. The base plate 90 has an adjustable valve plate slot 91 and height settings 92. The atomizing assembly 70 is directly coupled to the base plate 90. The metering valve 50 is indirectly attached to the base plate 90 via an adjustable valve plate 93. The metering valve 50 is operationally coupled to the adjustable valve plate 93 which extends through the adjustable valve plate slot 91 of the base plate 90. The adjustable valve plate 93 is able to move bi-directionally along the adjustable valve plate slot 91 as shown by the directional arrow.

The anaerobic, reactive fluid 13 is supplied under pressure from an anaerobic, reactive fluid reservoir 14, schematically drawn, through the fluid dispensing conduit 15 to the metering control 50 via the inlet port 51. The dispensing conduit 15 and the inlet port 51 are made of materials resistant to the anaerobic, reactive fluid 13 thereby preventing curing or setting of the fluid 13 therein. Such materials include but are not limited to linear polyoxymethylene acetal resin, polyetherimide, fluoropolymers such as polytetrafluoroethylene (PTFE), and the like. As the fluid 13 enters the inlet port 51, the stroke adjust 52 controls the volume of fluid 13 that enters the metering control 50. Rotation of the stroke adjust 52 regulates the flow of the fluid 13.

For example, the stroke adjust 52 may be rotated in a clockwise direction to decrease the flow of the fluid 13 and rotated in a counter-clockwise direction to increase the flow of fluid 13. Complete rotation of the stroke adjust 52 in the clockwise direction prohibits any flow of the fluid 13 while complete rotation of the stroke adjust 52 in the counter-clockwise direction allows for maximum flow of the fluid 13. Alternatively, a computerized control system, not shown, may also be employed to programmably operate the stroke adjust 52 as to regulate the volume of fluid 13 that flows from the dispensing conduit 15 to the metering control 50.

After the anaerobic, reactive fluid 13 flow has been set, the fluid 13 continues to flow from the inlet port 51 through the threaded fitting 56, the double ended male adapter 57, the Luer® lock 58, and out the needle 59 into the inlet chamber 71 of the atomizing assembly 70. The female joint of the fitting 56 is able to accommodate the double-ended male adapter 57 wherein a first end of the adapter 57 is conformed to couple with the fitting 56 by screwing a first end of the adapter 57 into the fitting 56. The second, distal end of the male adapter 57 not coupled to the fitting 56 is operably designed to couple with the Luer® lock 58. The first and the second, distal end of the double-ended male adapter 57 do not have to be identical in size. The function of the male adapter 57 is to interconnect the Luer® lock 58 of varying sizes with the threaded fitting 56.

The female joint of the Luer® lock 58 is screwed onto the second, distal end of the male adapter 57 leaving the male end of the joint of the Luer® lock 58 for coupling to the needle 59. The seals formed by coupling the aforementioned components to each other are sufficient to prevent leakage of the anaerobic, reactive fluid 13 as the fluid 13 flows from the inlet port 51 through the threaded fitting 56, double ended male adapter 57, Luer® lock 58, and out the needle 59 into the inlet chamber 71 of the atomizing assembly 70. The seals formed are also sufficient to prevent air from leaking into the components and contacting the fluid 13 causing setting of the anaerobic, reactive fluid 13 therein.

The components of the dispensing device 20 that are contacted by the anaerobic reactive fluid 13, the inlet port 51, the threaded fitting 56, the double-ended male adapter 57, and the needle 59, are made of materials resistant to the fluid 13 thereby preventing curing or setting of the fluid 13 therein. Such materials include but are not limited to linear polyoxymethylene acetal resin, polyetherimide, fluoropolymers such as polytetrafluoroethylene (PTFE), and the like. The aforementioned components are also easily removed from the dispensing device 20 for cleaning, replacement, or substitution with different components (e.g. size, material configuration) and are disposable.

From the inlet chamber 71, the anaerobic, reactive fluid 13 enters the atomizer 72. Compressed air is supplied to the atomizer 72 through the air inlet ports 73 whereupon contact of the compressed air with the fluid 13 atomizes the fluid 13 affording the atomized, anaerobic, reactive fluid 75 in the form of atomized droplets. After atomization, the atomized fluid 75 is carried via the compressed air to the spray nozzle 74 where the atomized fluid 75 is dispensed onto a workpiece 76 such as a substrate for coating purposes.

The metering valve 50 is operationally attached to the adjustable valve plate 93. The distance the tip of the needle 59 of the metering valve 50 extends into the inlet chamber 71 may be adjusted by moving the adjustable valve plate 93 bi-directionally along the directional arrow 94. The exact distance may be set by aligning a alignment notch 95 of the valve plate 93 with the height settings 92 of the base plate 90.

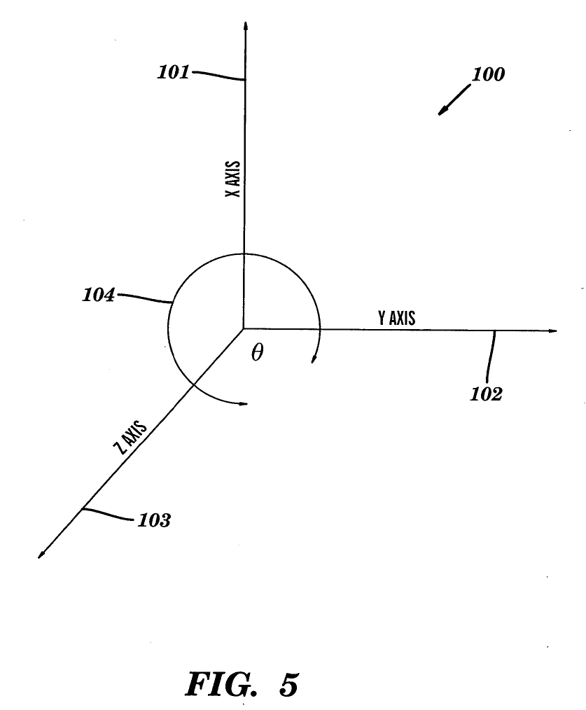

FIG. 5 depicts a Cartesian coordinate system 100 showing four axes of movement relevant to the present invention. The coordinate system 100 comprises an X axis 101, a Y axis 102, a Z axis 103, and a θ (theta) axis 104. The θ axis 104 constitutes circular motion about the Z axis 103.

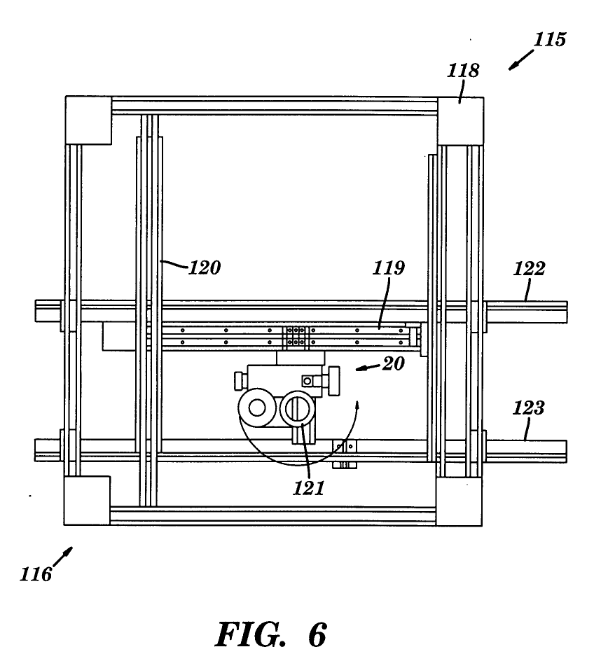

FIG. 6 depicts a top view of the dispensing system 115, in accordance with the present invention, comprising a reservoir 14, a dispensing device 20, and a multi-degree of freedom robotic apparatus 116. The reservoir 14 is a physical body for containing the anaerobic, reactive fluid 13. The reservoir may be in any form that is capable of containing the fluid 13. For example, a reusable cartridge, a reusable bag, a reusable container, a disposable cartridge, a disposable bag, a disposable container, and the like. The reservoir 14 is designed for containing anaerobic, reactive fluids 13 such as cyanoacrylate and the like.

The reservoir 14 is made of anaerobic, resistant materials that prevent setting or curing of the fluid 13 therein. The materials are chosen from a group consisting of linear polyoxymethylene acetal resin, polyetherimide, and fluoropolymers such as polytetralfuoroethylene, and the like. The reservoir 14 is operatively connected to and in fluid communication with the dispensing device 20 via the fluid dispensing conduit 15. The conduit 15 may be of any length and size that allows for fluid communication between the reservoir 14 and the dispensing device 20.

The dispensing device 20, previously described, has an internal surface for dispensing atomized, anaerobic reactive fluid 75. The device 20 receives the anaerobic, reactive fluid 13 from the reservoir 14 and then dispenses the fluid 13 in an atomized form being the atomized, anaerobic, reactive fluid 75. The device 20 may be operationally coupled to an apparatus, such as a multi-degree of freedom robotic positioning apparatus 116. The base plate 91 interconnects the dispensing device 20 and the robotic apparatus 116.

The multi-degree of freedom robotic positioning apparatus 116 comprises: a frame 118, a Y axis ball screw 119, an X axis ball screw slide 120, an end effector 121, a first frame member 122, and a second frame member 123. The effector 121 is capable of rotation about the θ axis 104 by moving left and right along the Y axis 102 by sliding along the Y axis ball screw slide 119. Similarly, the effector 121 moves back and forth along the X axis 101 by sliding, with the frame member 122 and the frame member 123, along the X axis ball screw slide 120.

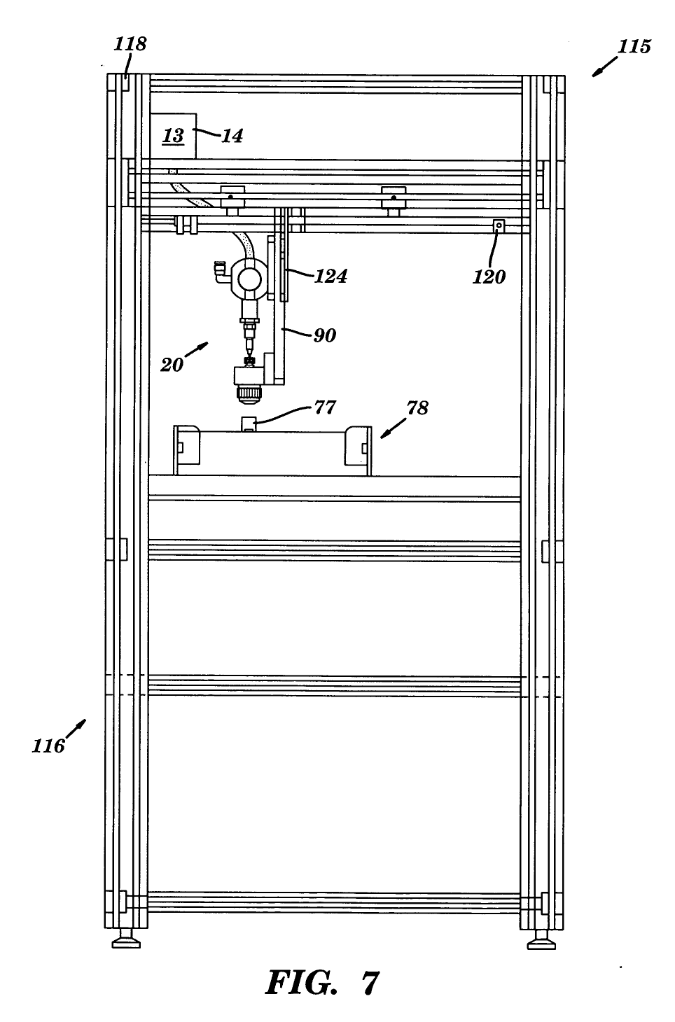

FIG. 7 depicts a side view of a dispensing system 115 of FIG. 6. The end effector 121 moves up and down on the Z axis 103 by sliding on the Z axis ball screw 124. The dispensing device 20 is shown in use dispensing atomized, anaerobic, reactive fluid onto a workpiece 75. In this example, the workpiece 75 is an electrical component 77 on a circuit board 78. As shown, the dispensing device 20 is operatively attached to the Z axis screw slide 124 via the base plate 90.

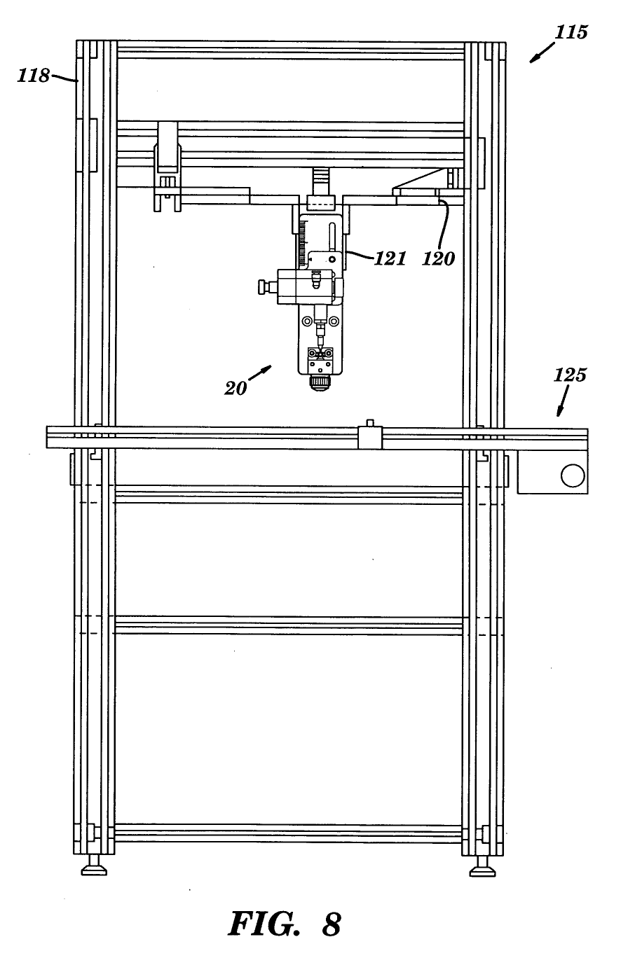

FIG. 8 depicts a front view of a dispensing system 115 of FIG. 6. As shown in FIG. 8, attached to the end effector 121 is the dispensing device 20. The dispensing device 20 combines anaerobic, reactive fluid 13 with compressed air to dispense an atomized, anaerobic, reactive fluid 75 onto a workpiece 76. Also shown, attached to the frame 118 is a belt conveyor 125. The conveyor 125 is used to move a workpiece 76 or object through the dispensing system 115 along to another station in a production process.

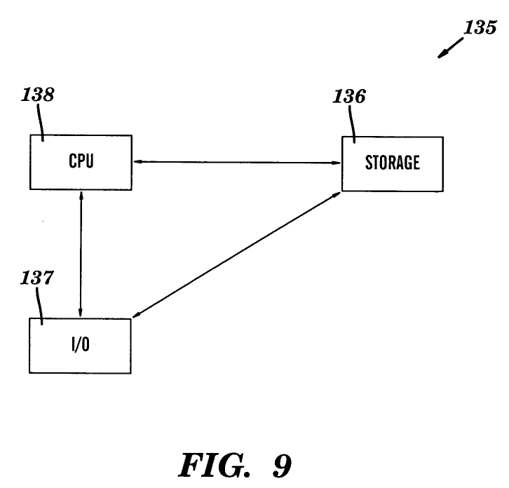

FIG. 9 depicts a block diagram of a controller 135 for use with the dispensing system in accordance with the present invention. The controller 135 comprises: a non-volatile memory, an Input/Output (I/O) device 137, and a central processing unit (CPU) 138. Although the controller 135 can take various forms, the controller 135 comprises a microprocessor based, stand-alone microcomputer. The controller 135 is progammably operable to perform simultaneous multi-axis coordinated motion with precision, accuracy, and repeatability.

A non-volatile memory 136 stores the control program and inputs, via the I/O device 137, and may comprise, for example, EEPROMs. The I/O device 137 may comprise, for example, a keyboard. The CPU 138 is at least 32-bit microprocessor. Performance characteristics include at least 8 million encoder inputs per second axis feedback, and at least 125 microsecond per axis position update rate.

Various modifications and variations of the described apparatus and methods of the invention will be apparent to those skilled in the art without departing from the scope and spirit of the invention. Although the invention has been described in connection with specific embodiments, outlined above, it should be understood that the invention should not be unduly limited to such specific embodiments. Various changes may be made without departing from the spirit and scope of the invention as defined in the following claims.

What is claimed is:

1. A device for dispensing anaerobic, reactive fluids comprising:
a metering control, wherein the metering control regulates a flow of an anaerobic, reactive fluid to an atomizer assembly; and
an atomizer assembly, made of the anaerobic, reactive fluid resistant material, wherein the atomizer assembly atomizes the anaerobic, reactive fluid affording an atomized anaerobic, reactive fluid, and further wherein the atomizer assembly includes a nozzle, made of an anaerobic, reactive fluid resistant material, wherein the nozzle dispenses onto a workpiece the atomized anaerobic, reactive fluid.

2. The device of claim 1, wherein a needle is made of an anaerobic, reactive fluid resistant material and further wherein the needle delivers the anaerobic, reactive fluid to the atomizer assembly.

3. The device of claim 1, wherein at least one anaerobic, reactive fluid dispensing conduit made of an anaerobic, reactive fluid resistant material, is operationally coupled to a metering control, made of an anaerobic, reactive fluid resistant material, and to a reservoir of the anaerobic, reactive material;

4. The device of claim 1, wherein the anaerobic, reactive fluid is cyanoacrylate.

5. The device of claim 1, wherein the anaerobic, reactive fluid resistant material is chosen from a group of consisting of: linear polyoxymethylene acetal resin, polyetherimide, and polytetrafluoroethylene.

6. The device of claim 2, wherein the needle is made of a fluoropolymer.

7. The device of claim 6, wherein the fluoropolymer is polytetrafluoroethylene.

8. The device of claim 1, further comprising: a valve housing;

9. The valve of claim 1, further comprising a fluid dispensing conduit screw securing the fluid dispensing conduit within the valve housing.

10. The device of claim 1, further comprising an internal anul.

11. The device of claim 1, further comprising a stroke adjustment screw regulating the metering control.

12. The device of claim 1, further comprising a threaded fitting connecting the fluid dispensing conduit to a luer lock.

13. The device of claim 1, further comprising the luer lock connecting the threaded fitting to a needle.

14. The device of claim 1, further comprising an adjustable valve plate positioning the valve at a variable distance above a substrate.

15. The device of claim 1, further comprising mounting plates connecting the valve to a multi-degree of freedom robotic apparatus.

16. A method for dispensing an anaerobic, reactive fluid comprising:
providing a dispensing device for dispensing an anaerobic, reactive fluid, wherein the anaerobic, reactive fluid is dispensed in an atomized form;
providing a reservoir for containing anaerobic, reactive fluid, wherein the reservoir is in fluid communication with the dispensing device; and
dispensing onto a workpiece the atomized, anaerobic, reactive fluid.

17. The method of claim 16, wherein the method further comprises coupling the dispensing device to a multi-degree of freedom robotic apparatus.

18. The method of claim 16, wherein the dispensing device further comprises at least one anaerobic, reactive fluid dispensing conduit made of an anaerobic, reactive fluid resistant material, operationally coupled to a metering control, made of an anaerobic, reactive fluid resistant material, and to a reservoir of said anaerobic, reactive material.

19. The method of claim 16, wherein the dispensing device further comprises a metering control for said anaerobic, reactive fluid, wherein said metering control regulates the flow of said anaerobic, reactive fluid to a needle.

20. The method of claim 16, wherein the dispensing device further comprises a needle, made of an anaerobic, reactive fluid resistant material, wherein said needle delivers the flow of said anaerobic, reactive fluid to an atomizer.

21. The method of claim 16, wherein the dispensing device further comprises an atomizer, made of an anaerobic, reactive fluid resistant material, for said anaerobic, reactive fluid, wherein said atomizer atomizes said anaerobic, reactive fluid affording an atomized anaerobic, reactive fluid.

22. The method of claim 16, wherein the dispensing device further comprises a nozzle, made of an anaerobic, reactive fluid resistant material, wherein the nozzle onto a workpiece the atomized anaerobic, reactive fluid.

22. The method of claim 16, wherein the reservoir of anaerobic, reactive fluid is cyanoacrylate.

23. The method of claim 16, wherein the anaerobic, reactive fluid resistant material is chosen from a group consisting of: linear polyoxymethylene acetal resin, polyetherimide, and polytetrafluorethylene.

25. A dispensing system comprising:
a reservoir for containing an anaerobic, reactive fluid;
a dispensing device having an internal surface for dispensing atomized, anaerobic, reactive fluid in fluid communication with the reservoir;
a multi-degree of freedom robotic apparatus operationally coupled to the dispensing device; and
a drive system, for supplying motive power to move the robotic apparatus in multi-degrees of freedom, the drive system operationally coupled to the robotic apparatus.

26. The dispensing system of claim 25, wherein the reservoir of fluid is cyanoacrylate.

27. The dispensing system of claim 25, wherein the dispensing valve comprises at least one component made of an anaerobic, reactive, fluid resistant material.

28. The dispensing system of claim 25, wherein the anaerobic, reactive, fluid resistant material is chosen from a group consisting of: linear polyoxymethylene acetal resin, polyetherimide, and polytetrafluoroethylene.
